(19) United States
(12) Patent Application Publication
(10) Pub. No.: US 2006/0215198 A1
(43) Pub. Date: Sep. 28, 2006

(54) Printing system, image reading apparatus and control method thereof

(75) Inventor: Kouji Yorimoto, Saitama (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/194,631

(22) Filed: Aug. 2, 2005

(30) Foreign Application Priority Data
Mar. 25, 2005 (JP) 2005-088755

(51) Int. Cl. G06F 3/12

(52) U.S. Cl. 358/1.13; 358/1.15

(57) ABSTRACT

A printing system including an image reading apparatus and a printing apparatus, in which the image reading apparatus has a selection section that selects a page description language that the printing apparatus can interpret, a print data processing section that creates print data by describing image data read by the image reading apparatus in the page description language selected by the selection section, and an output control section that transmits the print data created by the print data processing section to the printing apparatus, and in which the printing apparatus executes a printing process with respect to the image data by receiving the print data transmitted from the output control section and interpreting the page description language within the print data.

### BACKGROUND OF THE INVENTION

1. Field of the Invention

The present invention relates to a printing system, an image reading apparatus, and a control method thereof having an image reading apparatus that converts image data that has been read to print data described by a page description language for transmission, and a printing apparatus that executes a printing process with respect to the image data by receiving the print data from the image reading apparatus and interpreting the page description language within the print data, and more particularly to a printing system, an image reading apparatus, and a control method thereof in which print data described in the page description language supported by the output destination printing apparatus is transmitted from the image reading apparatus.

2. Description of the Related Art

With the lowering of prices of OA (office automation) devices such as copying machines and compound machines in recent years, it has become necessary for hardware manufacturers that provide these OA devices to take measures in response to this.

Consequently, as described in Japanese Patent Application Laid-Open No. 2002-314736 for example, scanner-printer systems (printing systems) have begun to be proposed that achieve a printing process such as copying by using a scanner and a printer in cooperation with each other.

With such a printing system, in addition to being able to achieve a printing process such as copying using a simple configuration, there is an advantage of being able to greatly suppress the installation costs involved compared to installing a compound machine or a copying machine.

When a printing process is to be carried out with cooperation between a scanner and a printer in this type of printing system, image data (bitmap data) is read by the scanner from an original and print data is created by describing the image data in a PDL (page description language) that the printer can interpret, then transmitting this print data to the printer in order. The printer executes a printing process of the image data according to the page description language.

That is to say, in addition to image data, page description language is included in the print data that is transmitted from the scanner to the printer. To carry out printing, the printer determines details such as the arrangement of the image data according to instructions in the page description language.

There are a plurality of types of page description languages such as those independently developed by the hardware manufacturer that provides the printer, and the language specifications of these are respectively different. Consequently, page description languages that have extensive sets of commands are employed in multifunction printers, but page description languages provided with only a necessary minimum set of commands are employed in simplified printers and the like, so that the page description languages supported by the printers are different.

Conventionally, when constructing an open printing system by arranging printers from a plurality of manufacturers, sometimes a situation occurs in which a printer cannot output since the page description language that is supported is different for each printer. Consequently, when constructing this type of printing system, the only method available to achieve this has been to use scanners and printers capable of handling page description languages of the same format.

Accordingly, the present invention has been devised in light of the above-described problems and provides a printing system, an image reading apparatus, and a control method thereof capable of carrying out a printing (copying) process in which the image reading apparatus and the printing apparatus work in cooperation regardless of the page description language supported by a printing apparatus of an output destination.

### SUMMARY OF THE INVENTION

An aspect of the present invention provides a printing system having an image reading apparatus that converts image data that has been read to print data described by a page description language for transmission, and a printing apparatus that executes a printing process with respect to the image data by receiving the print data from the image reading apparatus and interpreting the page description language within the print data; in which the image reading apparatus includes an image reading section that reads image data from an original, a selection section that selects a page description language that the printing apparatus can interpret, a print data processing section that creates print data by describing the image data read by the image reading section in the page description language selected by the selection section, and an output control section that transmits the print data created by the print data processing section to the printing apparatus, and in which the printing apparatus executes a printing process with respect to the image data by receiving the print data transmitted from the output control section and interpreting the page description language within the print data.

### BRIEF DESCRIPTION OF THE DRAWINGS

Embodiments of the present invention will be described in detail based on the following figures, wherein:

FIG. 1 is a block diagram showing one example of an overall configuration of a printing system according to a first example of the present invention;

FIG. 2 is a block diagram (one-to-one) showing one example of an overall configuration of a printing system according to the first example of the present invention;

FIG. 3 is a block diagram showing one example of an internal structure of a scanner 10 according to the first example of the present invention;

FIG. 4 is a diagram showing one example of a table layout of a printer information table 13;

FIG. 5 is a flowchart describing operations of a printing system according to the first example of the present invention;

FIG. 6 is a block diagram showing one example of an overall configuration of a printing system according to a second example of the present invention;

FIG. 7 is a block diagram (one-to-one) showing one example of an overall configuration of a printing system according to the second example of the present invention;

FIG. 8 is a block diagram showing an internal structure of a scanner 10 according to a second example of the present invention;

FIG. 9 is a diagram showing one example of a table layout of a priority level information management table 17;

FIG. 10 is a flowchart describing operations of the printing system according to the second example of the present invention;

FIG. 11 is a block diagram showing the internal structure of the scanner 10 according to a third example of the present invention;

FIG. 12 is a diagram showing one example of a table layout of a language characteristics information management table 19;

FIG. 13 is a flowchart describing operations of the printing system according to the third example of the present invention;

FIG. 14 is a diagram showing a modified example of the printing system according to the present invention;

FIG. 15 is a diagram showing a modified example of the printing system according to the present invention; and

FIG. 16 is a diagram showing a modified example of the printing system according to the present invention.

### DETAILED DESCRIPTION OF THE INVENTION

Embodiments of a printing system, an image reading apparatus, and a control method thereof according to the present invention are described in detail with reference to the accompanying drawings.

### EXAMPLE 1

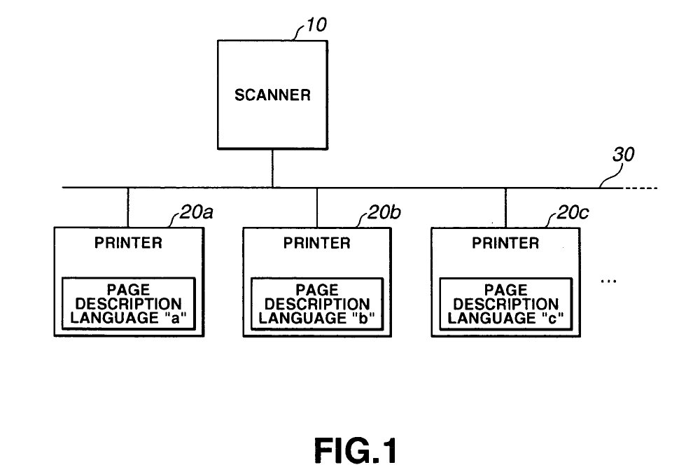

FIG. 1 is a block diagram showing one example of an overall configuration of a printing system according to the present invention.

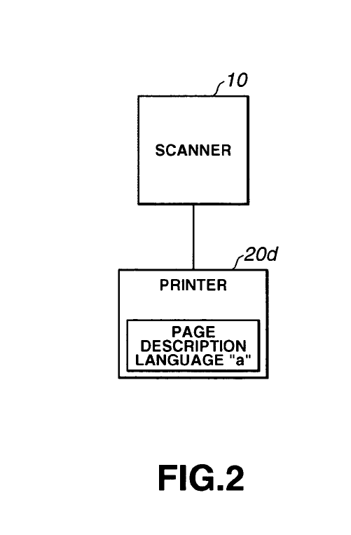

In this printing system, a scanner 10 and a plurality of printers 20 (printers 20a, 20b, and 20c are referred to by a general term, “printer(s) 20”) are connected via a LAN 30. It should be noted that description is given here using an example in which the respective devices are connected via the LAN (local area network) 30, but as long as the functionality of the present invention is achieved, it is possible to carry out the connection by a form other than a LAN. For example, the form of connection between the scanner 10 and a plurality of types of the printers 20 may be arranged in a one-to-one configuration as shown in FIG. 2.

The scanner 10 is an image reading apparatus that, by a scanning operation, reads graphics, photographs, or text and the like from an original mounted on a platen glass and converts these to digital data. The image data that is read here is transmitted to the printer 20 and a printing process thereof is executed by the printer 20.

Furthermore, as will be described in detail below, the scanner 10 is provided internally with a printer information table and whereby it identifies which page description languages are supported by the various printers 20. When an output destination printer 20 is selected by a user, the scanner 10 uses this table and creates print data described in a page description language that the output destination printer 20 supports (can interpret), and transmits this data to the printer 20.

The printer 20 is a printing apparatus that receives the print data sent from the scanner 10 and interprets the page description language within this print data to execute a printing process. By having the printer 20 work in cooperation with the scanner 10 to carry out print output at the printer 20 of the image data that has been read by the scanner 10, it is possible to achieve a copying function.

Furthermore, the page description languages that the printers 20 respectively support are different. For example, the printer 20a is able to carry out a printing process with respect to print data of a page description language “a” format, but does not support print data of a page description language “b” format and a page description language “c” format and is unable to carry out a printing process with respect to print data other than that in the format of the page description language “a.”

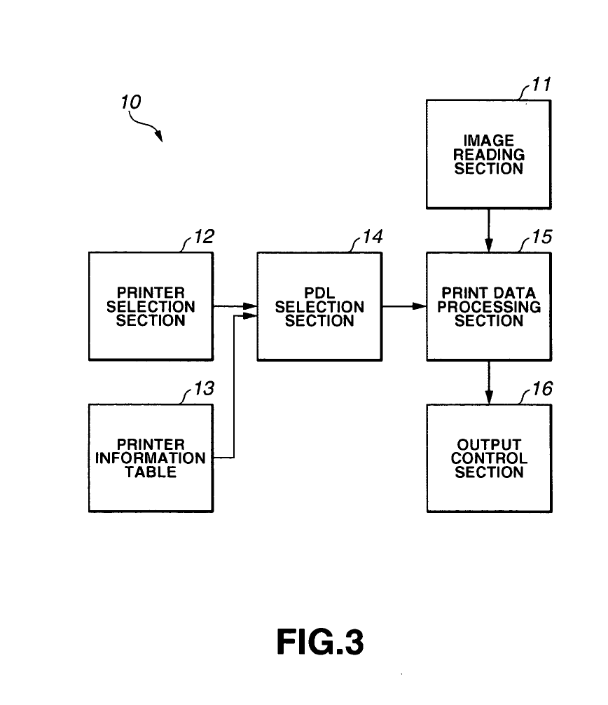

FIG. 3 is a block diagram showing an internal structure of the scanner 10 described in FIG. 1. It should be noted that only structural elements concerned with the present invention are described here.

The scanner 10 is configured provided with an image reading section 11, a printer selection section 12, a printer information table 13, a PDL selection section 14, a print data processing section 15, and an output control section 16 as functional sections for various processes.

The image reading section 11 is a processing section that reads image data from an original. Specifically, it is constituted by components such as an illumination lamp, a lens, and a CCD (charge coupled device). It optically scans the original mounted on the platen glass and outputs the obtained information as a bitmap image (image data).

The printer selection section 12 is a processing section by which a user selects the output destination printer 20. Specifically, a control panel provided with an input device, such as control buttons, and a display device, such an LED (light emitting diode) or an LCD (liquid crystal display), is installed at the scanner 10 main unit, with the printer selection section 12 corresponding to the input device therein.

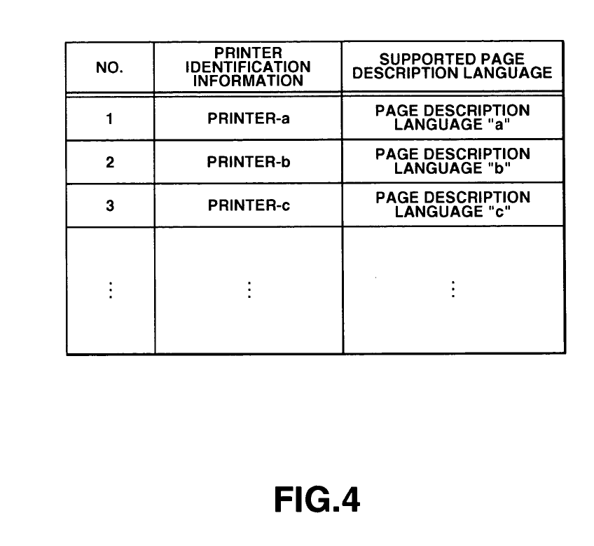

The printer information table 13 is a table for managing the page description languages supported by the printers 20. Specifically, as shown in FIG. 4, the page description languages supported by the printers 20 are maintained corresponding to printer identification information for identifying each of the printers 20.

The PDL selection section 14 is a processing section that selects the page description language supported by the output destination printer 20. Specifically, it searches the printer information table 13 and selects the page description language that is supported by the output destination printer 20 selected at the printer selection section 12.

The print data processing section 15 is a processing section that creates print data that is described in the page description language selected by the PDL selection section 14. For example, in a well-known technique such as that disclosed in Japanese Patent Application No. 2002-314736, print data is created according to the language structure of the selected page description language and appended as data to the beginning and end of the image data that has been read.

The output control section 16 is a processing section that transmits the print data, which contains image data, to the output destination printer 20. Specifically, it transmits the print data that contains image data and is described in the page description language selected by the PDL selection section 14 to the output destination printer 20 selected at the printer selection section 12. At the printer 20 that receives this print data, a printing process is executed with respect to the image data by interpreting the page description language in the print data. The above has been a description of each functional block showing the internal structure of the scanner 10 according to the present invention.

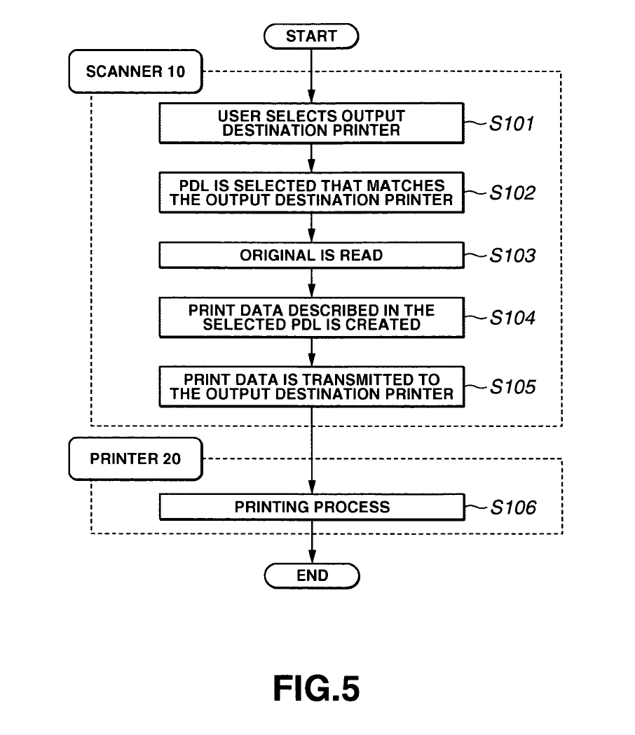

FIG. 5 is a flowchart describing operations of a printing system according to the present invention.

When this process commences, first an original is mounted on the platen glass of the scanner 10 and an output destination printer 20 is selected by a user from the printer selection section 12 (step S101).

When the output destination printer is selected, the PDL selection section 14 searches the printer information table 13 and selects the page description language that is supported by the output destination printer 20 selected at the printer selection section 12 (S102). Then, after the output destination printer is selected, image data is read from the original by the image reading section 11 when a start button is pushed by the user (step S103).

When the image data is read, the print data processing section 15 creates print data that is the read image data described in the page description language selected by the PDL selection section 14 (step S104).

The print data that is thus created and contains image data is sent by the output control section 16 to the output destination printer 20 selected by the printer selection section 12 (step S105). At the printer 20 that receives this print data, a printing process is executed with respect to the image data by interpreting the page description language in the print data (step S106), thereby completing this process.

As described above, in the present invention image data is read from an original by the scanner 10 and a page description language that the printer 20 of the output destination can interpret is selected. The image data that is read is made into print data described in the selected page description language and then sent to the printer 20. The printer 20 is configured so as to be able to execute a printing process with respect to the image data by interpreting the page description language in the received print data, and therefore a printing (copying) process can be carried out in which the scanner 10 and the printer 20 cooperate regardless of the page description language that the printer 20 of the output destination supports. For example, it is possible to construct an open printing system using a plurality of printers 20 provided by a plurality of manufacturers with each printer supporting different page description languages.

Furthermore, a user can select the desired printer 20 to execute a printing process without being aware of which page description language that printer 20 supports, and therefore complicated controls or the like are not required and convenience is improved.

### EXAMPLE 2

In example 2, an embodiment is described concerning a case in which, when the printers 20 support a plurality of page description languages, an optimal page description language is selected based on preset priority level information to execute a printing process.

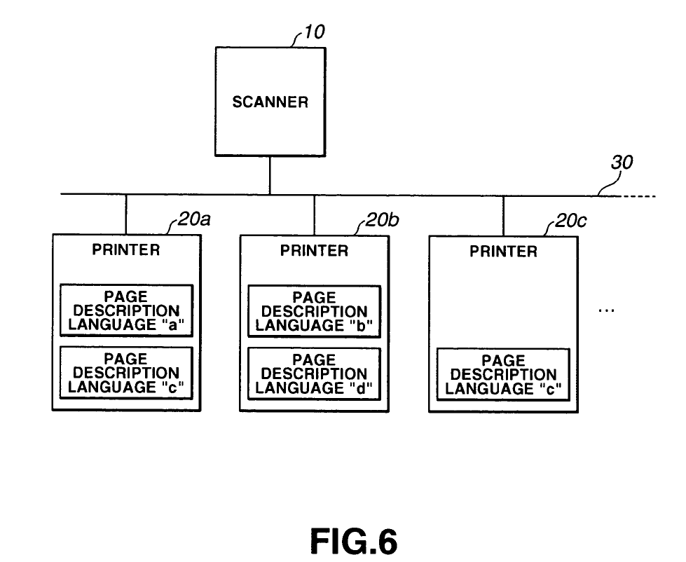

FIG. 6 is one example of a block diagram showing an overall configuration of a printing system according to example 2. It should be noted that elements having the same reference symbol as FIG. 1, in which example 1 is described, have substantially the same operation and therefore description will be given here concerning only the points of difference.

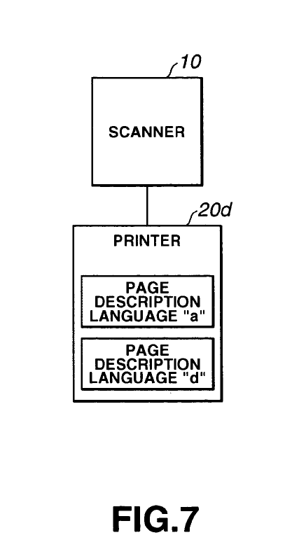

In this printing system, a scanner 10 and a plurality of printers 20 (printers 20a, 20b, and 20c are referred to by a general term, “printer(s) 20”) are connected via a LAN 30. It should be noted that, as in the above-described example 1, the form of connection between the scanner 10 and a plurality of types of the printer 20 may be arranged in a one to one configuration as shown in FIG. 7.

In addition to the printer information table, the scanner 10 is internally provided with a priority level information control table, which identifies which page description language(s) are supported by the printers 20 and maintains priority level information for selecting a specific page description language when the printer 20 supports a plurality of page description languages. When an output destination printer 20 is selected by a user, the scanner 10 uses these tables and creates print data described in a page description language that the output destination printer 20 supports (can interpret), and transmits this data to the printer 20.

The page description languages that the respective printers 20 support are different. For example, the printer 20a supports the page description language of page description language “a” and page description language “c,” while the printer 20b supports the page description language of page description language “b” and page description language “d.” That is, the printer 20a and the printer 20b support a plurality of types of page description languages.

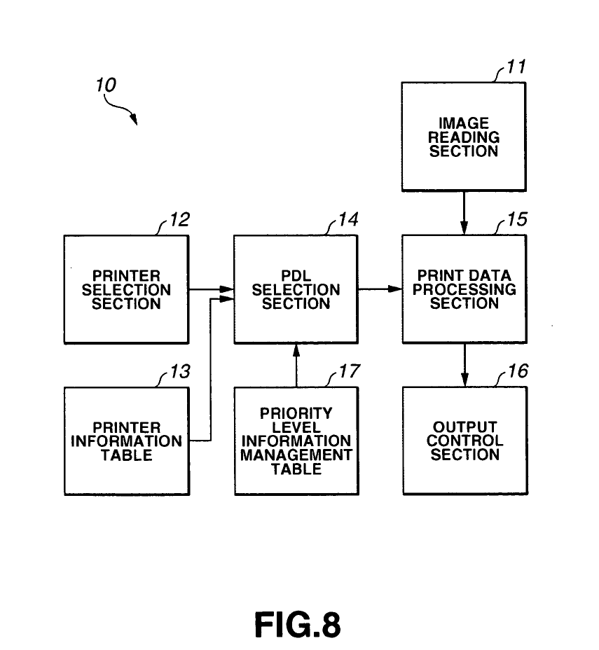

FIG. 8 is a block diagram showing an internal structure of the scanner 10 described in FIG. 6. It should be noted that elements having the same reference symbol as FIG. 3, in which example 1 is described, have substantially the same operation and therefore description will be given here concerning only the points of difference.

The scanner 10 is configured provided with an image reading section 11, a printer selection section 12, a printer information table 13, a PDL selection section 14, a print data processing section 15, an output control section 16, and a priority level information management table 17 as functional sections for various processes. That is, it is a configuration in which the priority level information management table 17 has been added to the configuration of FIG. 3 in which example 1 is described.

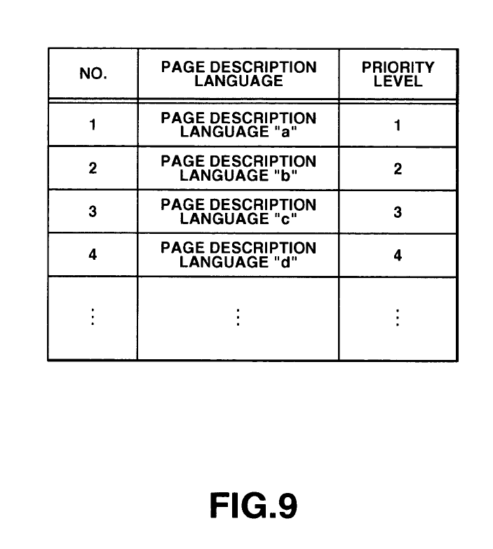

The priority level information management table 17 is a table for managing priority level information of page description languages. Specifically, as shown in FIG. 9, it maintains priority levels (priority order) corresponding to page description languages.

In the priority levels maintained in the priority level information management table 17, smaller values indicate a higher level of priority and larger values indicate a lower level of priority. When the output destination printer 20 supports a plurality of page description languages, the PDL selection section 14 selects the page description language that has the highest level of priority.

For example, when the user selects the printer 20a, which supports the page description language of the page description language “a” and the page description language “c,” as the output destination printer, the PDL selection section 14 will select the page description language “a” which has a higher level of priority (lower value). The above has been a description of each functional block showing the internal structure of the scanner 10 according to example 2.

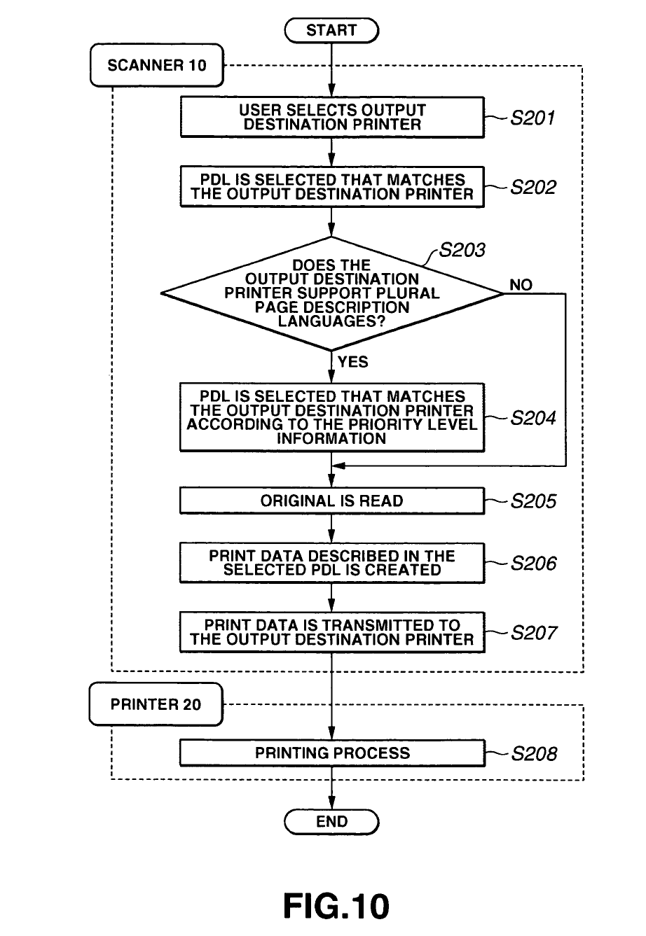

FIG. 10 is a flowchart describing operations of a printing system according to example 2.

When this process commences, first an original is mounted on the platen glass of the scanner 10 and an output destination printer 20 is selected by a user from the printer selection section 12 (step S201).

When the output destination printer is selected, the PDL selection section 14 searches the printer information table 13 and selects the page description language that is supported by the output destination printer selected at the printer selection section 12 (S202).

Here, when the output destination printer 20 supports a plurality of types of page description languages (“yes” at step S203), the PDL selection section 14 selects a specified page description language from the plurality of page description languages according to priority level information maintained in the priority level information management table 17 (step S204). Then, after the output destination printer is selected, image data is read from the original by the image reading section 11 when a start button is pushed by the user (step S205).

When the image data is read, the print data processing section 15 creates print data that is the read image data described in the page description language selected by the PDL selection section 14 (step S206).

The print data containing image data created in this way is transmitted by the output control section 16 to the output destination printer 20 selected by the printer selection section 12 (step S207). At the printer 20 that receives this print data, a printing process is executed with respect to the image data by interpreting the page description language in the print data (step S208), thereby completing this process.

In the above-described example 2, when the output destination printer supports a plurality of types of page description languages, the page description language is selected according to preset priority level information, and therefore an optimal page description language can be selected, which enables improvements in productivity and image quality.

### EXAMPLE 3

In example 3, an embodiment is described concerning a case in which, when the printers 20 support a plurality of types of page description languages, an optimal page description language is selected based on language characteristics of the page description languages to execute a printing process.

It should be noted that since the overall structure of the printing system according to example 3 is the same as example 2 described in FIGS. 6 and 7, description thereof will be omitted while description will be given here concerning the functional structure and operation.

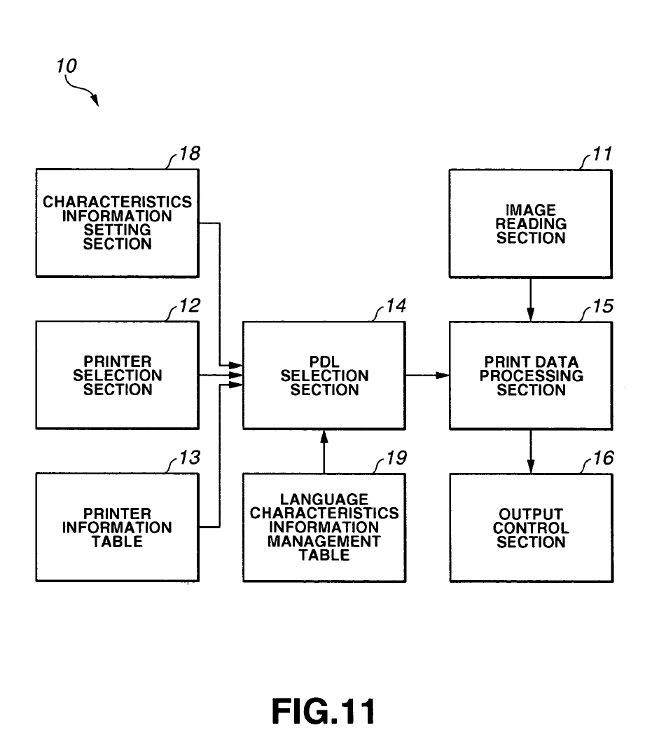

FIG. 11 is a block diagram showing an internal structure of the scanner 10 according to example 3. It should be noted that elements having the same reference symbol as FIG. 3, in which example 1 is described, have substantially the same operation and therefore description will be given here concerning only the points of difference.

The scanner 10 is configured provided with an image reading section 11, a printer selection section 12, a printer information table 13, a PDL selection section 14, a print data processing section 15, an output control section 16, a characteristics information setting section 18, and a language characteristics information management table 19 as functional sections for various processes. That is, it is a configuration in which the characteristics information setting section 18 and the language characteristics information management table 19 has been added to the configuration of FIG. 3 in which example 1 is described.

The characteristics information setting section 18 is a processing section for setting characteristics information of whether priority is given to image quality or priority is given to processing speed. Here, the characteristics information of whether priority is given to image quality or priority is given to processing speed is preset so that when the output destination printer 20 selected by the user at the printer selection section 12 supports a plurality of types of page description languages, the page description language is selected according to the characteristics information set here.

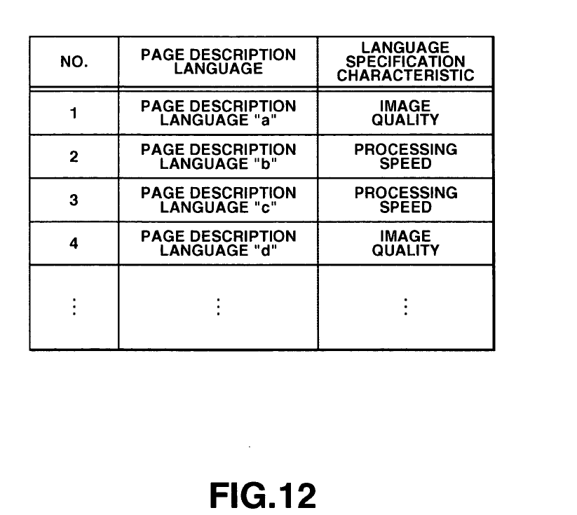

The language characteristics information management table 19 is a table for managing characteristics of the language specifications of page description languages. Specifically, as shown in FIG. 12, it maintains characteristics corresponding to page description languages based on the language specifications thereof. In language specification characteristics, information is set according to the language specifications of the page description language as to whether the page description language gives priority to color reproducibility and the like (image quality) or whether the page description language gives priority to compression of the amount of data (processing speed).

For example, if there is a page description language that supports YMCK whereas the other page description languages do not support YMCK, by carrying out color conversion from RGB to YMCK as well as screening at the scanner 10, it is possible to execute optimal image processing for the printing of that scanned image and achieve print output of much higher image quality than with the other page description languages, and therefore image quality is set as the language specification characteristic of that page description language.

Also, in a case where there is great divergence in the compression formats supported by the page description languages, by selecting the page description language that supports a compression format capable of the highest compression, it is possible to make the amount of data compact, that is, make the processing speed faster, and therefore processing speed is set as the language specification characteristic of this page description language.

The PDL selection section 14 is a processing section that selects the page description language supported by the output destination printer 20. When the output destination printer 20 supports a plurality of types of page description languages, the PDL selection section searches the language characteristics information management table 19 according to the characteristics information set in the characteristics information setting section 18 and selects a specified page description language. The above has been a description of each functional block showing the internal structure of the scanner 10 according to example 3.

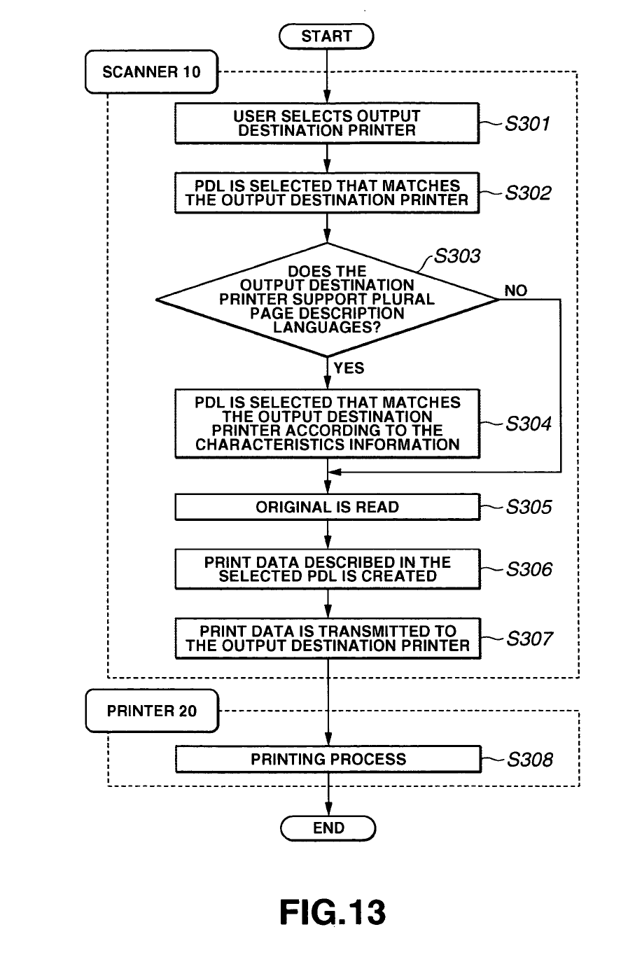

FIG. 13 is a flowchart describing operations of a printing system according to example 3.

When this process commences, first an original is mounted on the platen glass of the scanner 10 and an output destination printer 20 is selected by a user from the printer selection section 12 (step S301).

When the output destination printer is selected, the PDL selection section 14 searches the printer information table 13 and selects the page description language that is supported by the output destination printer selected at the printer selection section 12 (S302).

Here, when the output destination printer 20 supports a plurality of types of page description languages (“yes” at step S303), the PDL selection section 14 searches the language characteristics information management table 19 according to the characteristics information that has been set at the characteristics information setting section 18 and selects a specified page description language from the plurality of page description languages (step S304). Then, after the output destination printer is selected, image data is read from the original by the image reading section 11 when a start button is pushed by the user (step S305).

When the image data is read, the print data processing section 15 creates print data that is the read image data described in the page description language selected by the PDL selection section 14 (step S306).

The print data containing image data created in this way is transmitted by the output control section 16 to the output destination printer 20 selected by the printer selection section 12 (step S307). At the printer 20 that receives this print data, a printing process is executed with respect to the image data by interpreting the page description language in the print data (step S308), thereby completing this process.

In the above-described example 3, when the output destination printer supports a plurality of types of page description languages, the page description language is selected according to preset characteristics information, and therefore an optimal page description language can be selected, which enables improvements in productivity and image quality.

It should be noted that the present invention is not limited to the examples indicated in the above description and figures, and various modifications of the present invention are possible without straying from the spirit of the invention. For example, the following modifications are possible in the printing systems described in the above examples.

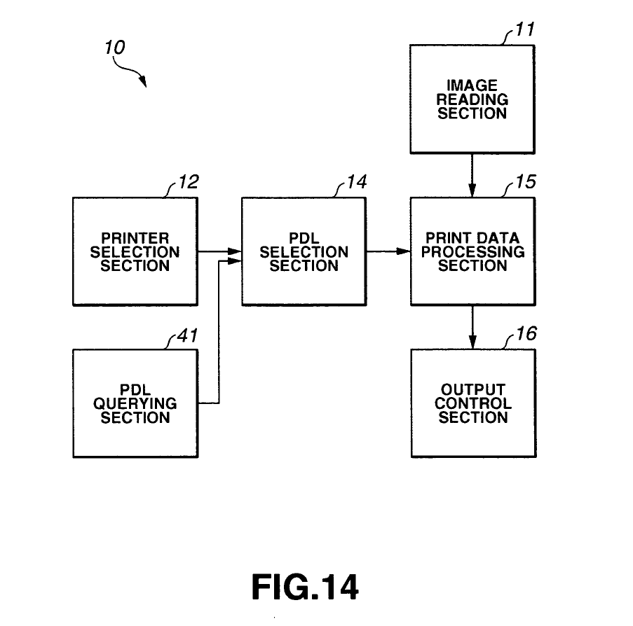

(a) As shown in FIG. 14, the printer information table 13 may be eliminated from the configuration of the scanner 10 shown in FIG. 3 in which example 1 is described and a PDL querying section 41 may be provided so that each time a printing process is to be carried out a query is made from scanner 10 to the output destination printer 20 about the page description language supported. In this case, no updating process is required for the printer information table 13 and no mismatch occurs with the page description language that the printer 20 actually supports. Naturally, this can be similarly applied to the scanners 10 of FIGS. 8 and 11 in which examples 2 and 3 are described.

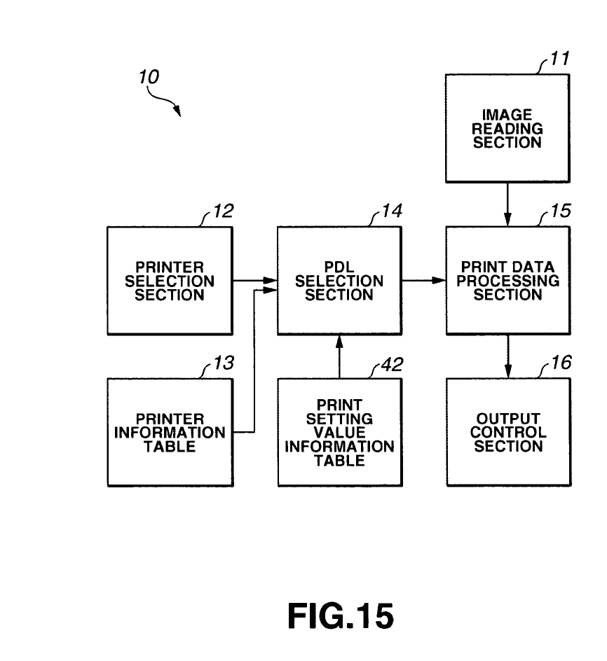

(b) As shown in FIG. 15, a print setting value information table 42 that manages the print setting value information that the page description language supports according to the page description language may be provided in the configuration of the scanner 10 shown in FIG. 3 in which example 1 is described, so that when the output destination printer 20 selected by the user supports a plurality of types of page description languages, it is possible to give priority to and select a page description language that supports the print setting value selected by the user. For example, when the output destination printer 20 is provided with a page description language that supports magnification/reduction settings and a page description language that does not support magnification/reduction settings and magnification/reduction settings are applied by the user, the PDL selection section 14 searches the print setting value information table 42 and selects the page description language that supports the print setting values (in this case, magnification/reduction settings) selected by the user.

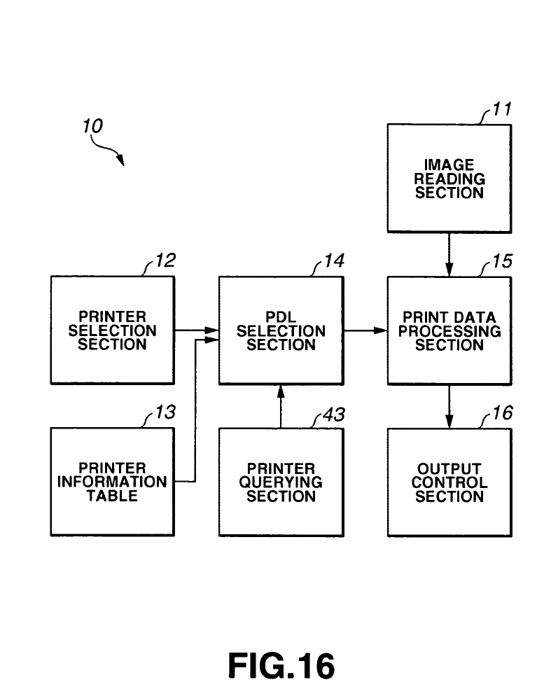

(c) As shown in FIG. 16, a printer querying section 43 that queries the printer 20 about information (for example, printer name) in order to specify the classification of the printer 20 may be provided in the configuration of the scanner 10 shown in FIG. 3 in which example 1 is described, and based on the result of the query by the printer querying section 43, the printer information table 13 is searched and a page description language that the printer 20 supports can be selected. In particular, when the form of connection of the scanner 10 and the printer 20 is one-to-one as shown in FIG. 2, the optional printer 20 is connected but in this case too the page description language supported by the printer 20 can be accurately selected.

It should be noted that in addition to examples 1 to 3, description was given concerning printing systems according to the present invention using modified examples, but it is also possible to achieve embodiments in which all or a part of the examples 1 to 3 or the modified examples are combined.

As described above, a first aspect of the present invention provides a printing system including an image reading apparatus that converts image data that has been read to print data described by a page description language for transmission, and a printing apparatus that executes a printing process with respect to the image data by receiving the print data from the image reading apparatus and interpreting the page description language within the print data, in which the image reading apparatus includes: an image reading unit that reads image data from an original; a selection unit that selects a page description language that the printing apparatus can interpret; a print data processing unit that creates print data by describing the image data read by the image reading unit in the page description language selected by selection unit; and an output control unit that transmits the print data created by the print data processing unit to the printing apparatus, in which the printing apparatus executes a printing process with respect to the image data by receiving the print data transmitted from the output control unit and interpreting the page description language within the print data.

Further, a second aspect of the present invention provides the printing system according to the first aspect of the invention, in which the image reading apparatus may further include a priority level information management unit that manages priority level information of the page description language, and in which the selection unit may select a specific page description language based on the priority level information of the priority level information management unit when the printing apparatus supports plural types of page description languages.

Further, a third aspect of the present invention provides the printing system according to the first aspect of the invention, in which the image reading apparatus may further include: a characteristics information setting unit that sets characteristics information when selecting the page description language; and a language characteristics information management unit that manages language specification characteristics of the page description language, in which, when the printing apparatus supports plural types of page description languages, the selection unit may select a specific page description language suited to the language specification characteristics managed by the language characteristics information management unit based on the characteristics information that has been set by the characteristics information setting unit.

Further, a fourth aspect of the present invention provide the printing system according to the first aspect of the invention, in which the image reading apparatus may further include: a priority level information management unit that manages priority level information of the page description language; a characteristics information setting unit that sets characteristics information when selecting the page description language; and a language characteristics information management unit that manages language specification characteristics of the page description language, in which, when the printing apparatus supports plural types of page description languages, the selection unit may select a specific page description language suited to the language specification characteristics managed by the language characteristics information management unit based on the priority level information of the priority level information management means and the characteristics information set by the characteristics information setting unit.

Further, a fifth aspect of the present invention provides the printing system according to any of the first to fourth aspects of the invention, in which the image reading apparatus may further include a printing apparatus information maintaining unit that manages which language is the page description language supported by the printing apparatus, and the selection unit may select the page description language the printing apparatus can interpret based on information managed in the printing apparatus information maintaining unit.

Further, a sixth aspect of the present invention provides the printing system according to any of the first to fourth aspects of the invention, in which the image reading apparatus further comprises a first querying unit that queries the printing apparatus concerning the page description language that is supported, and the selection unit may select the page description language the printing apparatus can interpret according to a result of querying by the first querying unit.

Further, a seventh aspect of the present invention provides the printing system according to any of the first to fifth aspects of the invention, in which the image reading apparatus may further include a second querying unit that queries the printing apparatus concerning information that specifies the printing apparatus, and the selection unit may select the page description language the printing apparatus can interpret according to a result of querying by the second querying unit.

Further, an eighth aspect of the present invention provides the printing system according to any of the first to sixth aspects of the invention, in which the image reading apparatus may further include a printing apparatus selecting unit that selects an output destination printing apparatus from plural printing apparatuses, and the selection unit may select the page description language that can be interpreted by the output destination printing apparatus that is selected by the printing apparatus selecting unit.

Further, a ninth aspect of the present invention provides an image reading apparatus that reads image data and transmits the read image data to a printing apparatus to perform a print request, including: an image reading unit that reads image data from an original; a selection unit that selects a page description language that the printing apparatus can interpret; a print data processing unit that creates print data by describing the image data read by the image reading unit in the page description language selected by the selection unit; and an output control unit that transmits the print data created by the print data processing unit to the printing apparatus.

Further, a tenth aspect of the present invention provides a control method of a printing system comprising an image reading apparatus that converts image data that has been read to print data described by a page description language for transmission, and a printing apparatus that executes a printing process with respect to the image data by receiving the print data from the image reading apparatus and interpreting the page description language within the print data; the method including: reading, by an image reading unit of the image reading apparatus, data from an original; selecting, by a selection unit of the image reading apparatus, the page description language that the printing apparatus can interpret; creating, by a print data processing unit of the image reading apparatus, print data by describing the image data that has been read by the image reading unit in the page description language selected by the selection unit; transmitting, by an output control unit of the image reading apparatus, the print data created by the print data processing unit to the printing apparatus; and executing, by the printing apparatus, a printing process with respect to the image data by receiving the print data transmitted from the output control unit and interpreting the page description language within the print data.

According to the above-mentioned aspects of the present invention, image data is read from an original at the image reading apparatus and a page description language that the printing apparatus of the output destination can interpret is selected. The image data that is read is made into print data described in the selected page description language and then sent to the printing apparatus. The printing apparatus is configured so as to be able to execute a printing process with respect to the image data by interpreting the page description language in the received print data, and therefore a printing (copying) process can be carried out in which the image reading apparatus and the printing apparatus cooperate regardless of the page description language that the printing apparatus of the output destination supports. For example, it is possible to construct an open printing system using a plurality of printing apparatuses provided by different manufacturers with each supporting different page description languages.

Furthermore, a user can select the desired printing apparatus to execute a printing process without being aware of which page description language that printing apparatus supports, and therefore complicated controls or the like are not required and convenience is improved.

The printing system, the image reading apparatus, and the control method thereof according to the present invention can be applied to an entire printing system in which an image reading apparatus and a printing apparatus are arranged. In particular, it is possible to achieve a simple and low-cost configuration in which the image reading apparatus and the printing apparatus cooperate to carry out printing (copying) processes, and therefore can be effectively used in offices and businesses where copying work is frequently carried out.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-88755 filed on Mar. 25, 2005 including specification, claims, drawings and abstract is incorporated herein by reference in its entirety.

1. A printing system comprising an image reading apparatus that converts image data that has been read to print data described by a page description language for transmission, and a printing apparatus that executes a printing process with respect to the image data by receiving the print data from the image reading apparatus and interpreting the page description language within the print data,
wherein the image reading apparatus comprises:
an image reading unit that reads image data from an original;
a selection unit that selects a page description language that the printing apparatus can interpret;
a print data processing unit that creates print data by describing the image data read by the image reading unit in the page description language selected by selection unit; and
an output control unit that transmits the print data created by the print data processing unit to the printing apparatus,
wherein the printing apparatus executes the printing process with respect to the image data by receiving the print data transmitted from the output control unit and interpreting the page description language within the print data.

2. The printing system according to claim 1,
wherein the image reading apparatus further comprises a priority level information management unit that manages priority level information of the page description language, and
wherein the selection unit selects a specific page description language based on the priority level information of the priority level information management unit when the printing apparatus supports plural types of page description languages.

3. The printing system according to claim 1,
wherein the image reading apparatus further comprises:
a characteristics information setting unit that sets characteristics information when selecting the page description language; and
a language characteristics information management unit that manages language specification characteristics of the page description language,
wherein, when the printing apparatus supports plural types of page description languages, the selection unit selects a specific page description language suited to the language specification characteristics managed by the language characteristics information management unit based on the characteristics information that has been set by the characteristics information setting unit.

4. The printing system according to claim 1,
wherein the image reading apparatus further comprises:
a priority level information management unit that manages priority level information of the page description language;
a characteristics information setting unit that sets characteristics information when selecting the page description language; and
a language characteristics information management unit that manages language specification characteristics of the page description language,
wherein, when the printing apparatus supports plural types of page description languages, the selection unit selects a specific page description language suited to the language specification characteristics managed by the language characteristics information management unit based on the priority level information of the priority level information management means and the characteristics information set by the characteristics information setting unit.

5. The printing system according to claim 1,
wherein the image reading apparatus further comprises a printing apparatus information maintaining unit that manages which language is the page description language supported by the printing apparatus, and
the selection unit selects the page description language the printing apparatus can interpret based on information managed in the printing apparatus information maintaining unit.

6. The printing system according to claim 2,
wherein the image reading apparatus further comprises a printing apparatus information maintaining unit that manages which language is the page description language supported by the printing apparatus, and
the selection unit selects the page description language the printing apparatus can interpret based on information managed in the printing apparatus information maintaining unit.

7. The printing system according to claim 3,
wherein the image reading apparatus further comprises a printing apparatus information maintaining unit that manages which language is the page description language supported by the printing apparatus, and
the selection unit selects the page description language the printing apparatus can interpret based on information managed in the printing apparatus information maintaining unit.

8. The printing system according to claim 4,
wherein the image reading apparatus further comprises a printing apparatus information maintaining unit that manages which language is the page description language supported by the printing apparatus, and
the selection unit selects the page description language the printing apparatus can interpret based on information managed in the printing apparatus information maintaining unit.

9. The printing system according to claim 1,
wherein the image reading apparatus further comprises a first querying unit that queries the printing apparatus concerning the page description language that is supported, and
the selection unit selects the page description language the printing apparatus can interpret according to a result of querying by the first querying unit.

10. The printing system according to claim 2,
wherein the image reading apparatus further comprises a first querying unit that queries the printing apparatus concerning the page description language that is supported, and
the selection unit selects the page description language the printing apparatus can interpret according to a result of querying by the first querying unit.

11. The printing system according to claim 3,
wherein the image reading apparatus further comprises a first querying unit that queries the printing apparatus concerning the page description language that is supported, and
the selection unit selects the page description language the printing apparatus can interpret according to a result of querying by the first querying unit.

12. The printing system according claim 4,
wherein the image reading apparatus further comprises a first querying unit that queries the printing apparatus concerning the page description language that is supported, and
the selection unit selects the page description language the printing apparatus can interpret according to a result of querying by the first querying unit.

13. The printing system according to claim 1,
wherein the image reading apparatus further comprises a second querying unit that queries the printing apparatus concerning information that specifies the printing apparatus, and
the selection unit selects the page description language the printing apparatus can interpret according to a result of querying by the second querying unit.

14. The printing system according to claim 1,
wherein the image reading apparatus further comprises a printing apparatus selecting unit that selects an output destination printing apparatus from plural printing apparatuses, and
the selection unit selects the page description language that can be interpreted by the output destination printing apparatus that is selected by the printing apparatus selecting unit.

15. An image reading apparatus that reads image data and transmits the read image data to a printing apparatus to perform a print request, comprising:
an image reading unit that reads image data from an original;
a selection unit that selects a page description language that the printing apparatus can interpret;
a print data processing unit that creates print data by describing the image data read by the image reading unit in the page description language selected by the selection unit; and
an output control unit that transmits the print data created by the print data processing unit to the printing apparatus.

16. A control method of a printing system comprising an image reading apparatus that converts image data that has been read to print data described by a page description language for transmission, and a printing apparatus that executes a printing process with respect to the image data by receiving the print data from the image reading apparatus and interpreting the page description language within the print data; comprising:
reading, by an image reading unit of the image reading apparatus, data from an original;
selecting, by a selection unit of the image reading apparatus, the page description language that the printing apparatus can interpret;
creating, by a print data processing unit of the image reading apparatus, print data by describing the image data that has been read by the image reading unit in the page description language selected by the selection unit;
transmitting, by an output control unit of the image reading apparatus, the print data created by the print data processing unit to the printing apparatus; and
executing, by the printing apparatus, a printing process with respect to the image data by receiving the print data transmitted from the output control unit and interpreting the page description language within the print data.
